(19) United States
(12) Patent Application Publication
(10) Pub. No.: US 2010/0084947 A1
(43) Pub. Date: Apr. 8, 2010

(54) High Efficiency Piezoelectric Energy Harvester Having Spiral Structure

(75) Inventors: Seok-Jin YOON, Seoul (KR); Hyun Cheol SONG, Seoul (KR); Chong Yun KANG, Seoul (KR); Jin Sang KIM, Seoul (KR)

Correspondence Address: JONES DAY, 222 EAST 41ST ST, NEW YORK, NY, 10017, US

(73) Assignee: Korea Institute of Science and Technology

(21) Appl. No.: 12/572,185

(22) Filed: Oct. 1, 2009

(30) Foreign Application Priority Data
Oct. 2, 2008 (KR) 10-2008-0097375

(51) Int. Cl. H02N 2/18

(52) U.S. Cl. 310/339

(57) ABSTRACT

The present invention relates to a piezoelectric energy harvester having a high energy transformation efficiency and a low natural frequency. The piezoelectric energy harvester includes an elastic substrate having a spiral spring structure, a first electrode formed on the elastomeric substrate, a piezoelectric film formed on the first electrode and a second electrode formed on the piezoelectric film.

The present application claims priority from Korean Patent Application No. 10-2008-0097375 filed on Oct. 2, 2008, the entire subject matter of which is incorporated herein by reference.

### BACKGROUND OF THE INVENTION

1. Technical Field

The present invention generally relates to piezoelectric energy harvesters, and more particularly to a piezoelectric energy harvester having a high efficiency for energy transformation and a low natural frequency.

2. Background Art

Piezoelectric energy harvesting is a process used to derive energy from ambient vibrations using piezoelectric materials. The ambient vibrations may be generated by a train, a vacuum pump, a mechanical motor, a car engine, a human's motion and so forth.

Recently, a ubiquitous sensor network has been researched and developed for improving the quality of human life. In order to build a ubiquitous sensor network, it is necessary to install a plurality of sensors on a large area. However the cost is high to connect an electric wire in each sensor for supplying power, charging a battery and recharging the battery. The piezoelectric energy harvesting technique, which can drive the sensors independently by using ambient energy, is certainly necessary to fabricate the ubiquitous sensor network. This is especially true since piezoelectric energy harvesting using vibration energy is time-independent and location-independent, and has a high efficiency for energy transformation.

### BRIEF DESCRIPTION OF THE DRAWINGS

FIG. 1 is schematic diagram showing a cantilever type piezoelectric energy harvester.

FIG. 2 is a schematic diagram showing an illustrative embodiment of a circular spiral spring type piezoelectric energy harvester.

FIG. 3 is a schematic diagram showing an illustrative embodiment of a beam of the piezoelectric energy harvester.

FIG. 4 is a schematic diagram showing an illustrative embodiment of a circular spiral spring type piezoelectric energy harvester.

FIG. 5 is a schematic diagram showing an illustrative embodiment of a tetragonal spiral spring type piezoelectric energy harvester.

### DETAILED DESCRIPTION OF THE INVENTION

A detailed description may be provided with reference to the accompanying drawings. One of ordinary skill in the art may realize that the following description is illustrative only and is not in any way limiting. Other embodiments of the present invention may readily suggest themselves to such skilled persons having the benefit of this disclosure.

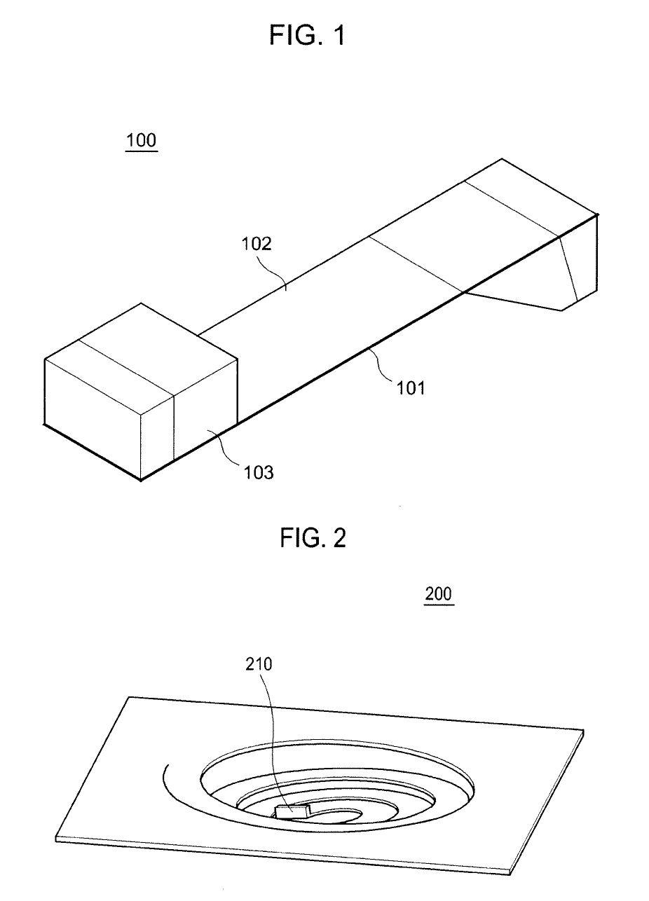

FIG. 1 is schematic diagram showing a cantilever type piezoelectric energy harvester. The cantilever type piezoelectric energy harvester 100 may include a substrate 101, a piezoelectric element 102 and a proof mass 103. The cantilever type piezoelectric energy harvester 100 may be fabricated to be small in size (micro) by using microelectromechanical systems (MEMS) for forming sensors, thin film rechargeable batteries and the piezoelectric energy harvesters on one chip. In this case, a natural frequency of the piezoelectric energy harvesting element may increase over hundreds of Hz. Because the frequency of an ambient vibration source is below 200 Hz, the cantilever type piezoelectric energy harvesting element may not resonate with the ambient vibration source through frequency tuning. An efficiency of energy transformation may be proportional to the piezoelectric constant. The piezoelectric energy harvester using a 31-mode (d₃₁) piezoelectric constant has a lower efficiency of energy transformation than the piezoelectric energy harvester using a 33-mode (d₃₃) piezoelectric constant. Generally, the piezoelectric constant has a relationship of 3d₃₁≈d₃₃.

FIG. 2 is a schematic diagram showing an illustrative embodiment of a piezoelectric energy harvester. As illustrated in FIG. 2, the piezoelectric energy harvester 200 may be fabricated to have a spiral spring structure. Reference numeral “210” in FIG. 2 represents a proof mass.

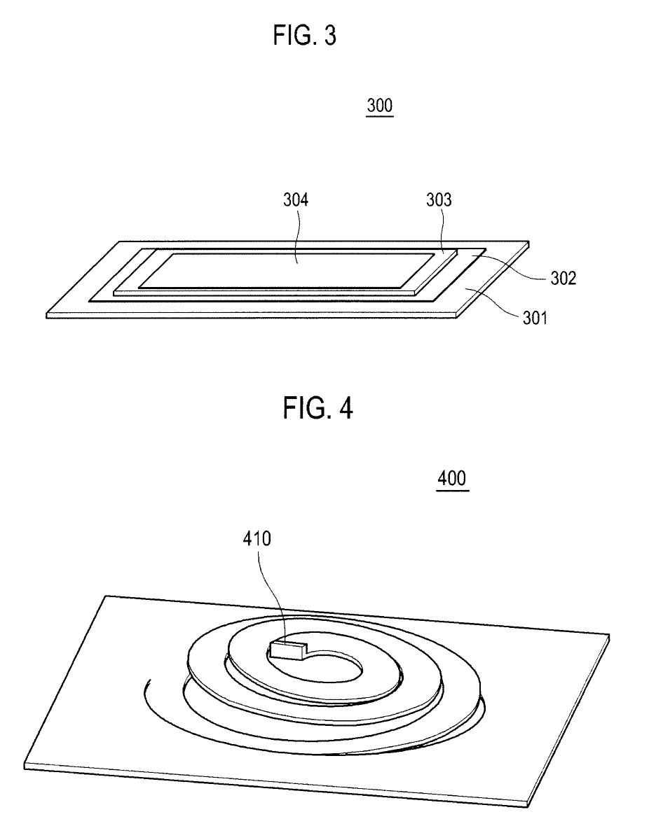

The spiral spring structure of the piezoelectric energy harvester 200 may be made by processing a beam of the piezoelectric energy harvester illustrated in FIG. 3. Referring to FIG. 3, the beam 300 of the piezoelectric energy harvester 200 may include an elastic substrate 301, a first electrode 302 formed on the elastic substrate 301, a piezoelectric film 303 formed on the first electrode 302 and a second electrode 304 formed on the piezoelectric film 303. The first electrode 302, a piezoelectric film 303 and a second electrode 304 may be formed by thin film techniques such as sputtering and evaporation or depending upon the material, by printing techniques.

When mechanical pressure is applied to the piezoelectric film 303, polarization change may occur along a direction perpendicular to the first and second electrode 302 and 304 to thereby produce a voltage. In one embodiment, when the piezoelectric energy harvester 200 is fabricated using microelectromechanical systems (MEMS), the elastic substrate 301 may be formed by a silicon (Si) wafer or a silicon nitride (SiN) deposited on a silicon wafer. The elastic substrate 301 may further comprises a film formed by one of spring-steel, copper, brass, bronze, glass fiber and fiber reinforced plastic, but the materials are not limited thereto. The first and second electrode 302 and 304 may be formed using silver, platinum, gold, aluminum, nickel, copper-nickel alloy, but the materials are not limited thereto. The piezoelectric film 203 may be formed by a ceramic thick film or a thin film made one of gallium orthophosphate, lanthanum gallium silicate, barium titanate, lead titanate, potassium niobate, lithium niobate, lithium tantalate, sodium tungstate, lead zirconate titanate (PZT) series, but the material are not limited thereto.

When the piezoelectric energy harvester 200 resonates with an ambient vibration source, displacement of the piezoelectric energy harvester 200 may be maximized to thereby produce a maximum voltage. An energy transformation efficiency of mechanical to electrical energy may be maximized at resonance. For the resonance of the piezoelectric energy harvester 200 with the ambient vibration source, a natural frequency of the piezoelectric energy harvester 200 should be set identical to a frequency of the ambient vibration source. The natural frequency of the piezoelectric energy harvester 200 may be closely related with a dimension thereof. The ambient vibration source generally has a frequency of below 200 Hz. When the piezoelectric energy harvester is fabricated using the MEMS, in some embodiments the natural frequency may be above 200 Hz due to size. In order to lower the natural frequency, a proof mass 210, which may be attached on an end of the beam of the piezoelectric energy harvester, can be used. Generally, the natural frequency of the piezoelectric energy harvester may be calculated using the following equation.

$${f}_{natural} = {\frac{1}{2 π} [ \frac{3 EI}{{L}^{3} ( M + 0.24 {M}_{b} )} ]}^{1 / 2} \qquad ( 1 )$$

wherein “fₙₐₜᵤᵣₐₗ” indicates the natural frequency of the piezoelectric energy harvester 200, “E” indicates Young's modulus, “I” indicates a moment of Inertia, “M” indicates a weight of a proof mass 210, “M_{b}” indicates a weight of a beam and “L” indicates a length of the beam 300. As can be understood from equation (1), the natural frequency is inversely proportional to the length of the beam and the weights of the beam and the proof mass 210.

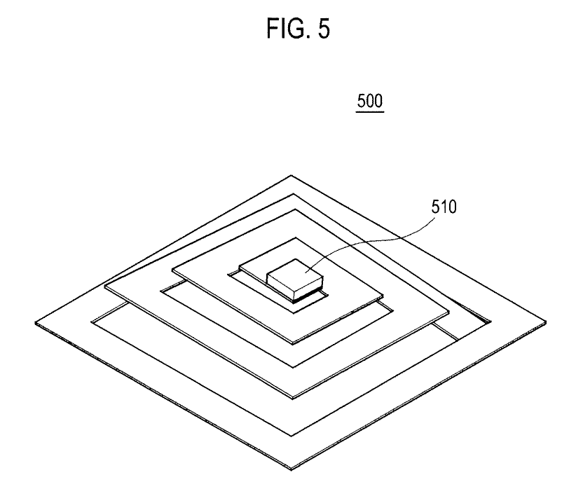

When the piezoelectric energy harvester 200 is fabricated using the MEMS, a heavy proof mass 210 may not be used to lower the natural frequency because the piezoelectric energy harvester 200 may be damaged during the vibration of the piezoelectric energy harvester 200. Accordingly, it may be difficult to lower the natural frequency of the piezoelectric energy harvester 200 using the proof mass 210 only. In one embodiment, the piezoelectric energy harvester 200 may be fabricated to have a circular spiral spring structure. However, the shape of the piezoelectric energy harvester may not be limited thereto. In another embodiment, the piezoelectric energy harvester may be fabricated to have various spiral spring structures such as a circular or polygonal spiral spring structure, etc., as illustrated in FIGS. 4-5. The polygonal spiral spring structure may include spiral spring structures having the shape of a triangle, tetragon, hexagon, octagon and the like. In FIGS. 4-5, numeral references “410” and “510” represent proof masses.

In one embodiment, since the piezoelectric energy harvester is fabricated to have the spiral spring structure, the length of the beam of the piezoelectric energy harvester can be extended within a limited size thereof. Thus, the natural frequency may be lowered to a frequency below 200 Hz. The electromechanical coupling factor of the piezoelectric energy harvester 200, which indicates an energy transformation efficiency thereof, may be calculated using the following equation.

$${k}^{2} = \frac{{d}^{2}}{s \cdot {K}_{33}} = \frac{d \cdot g}{s} = \frac{{d}^{2} Y}{{K}_{33}} \qquad ( 2 )$$

wherein “k” indicates an electro-mechanical coupling factor of the piezoelectric energy harvester 200, “d” indicates a piezoelectric constant, “g” indicates a piezoelectric voltage constant, “Y” indicates the Young's modulus, “K” indicates a relative permittivity and “s” indicates an elastic compliance.

In one embodiment, a 15-mode (d₁₅) piezoelectric constant may be used when a shear stress is applied to the piezoelectric energy harvester 200, instead of a 31 mode (d₃₁) piezoelectric constant which may be used when the displacement direction is perpendicular to an electric field. The piezoelectric constant d₃₁ is typically used in the conventional piezoelectric energy harvester 100 having a cantilever structure. Generally, the piezoelectric constant has a relationship of 3d₃₁≈d₃₃<d₁₅. Thus, the electromechanical coupling factor “k” representing the energy transformation efficiency of the piezoelectric energy harvester 200 may be greater than that of the piezoelectric energy harvester 100 having a cantilever structure.

In one embodiment, an inactive region of the piezoelectric energy harvester 200, which represents an empty space necessary for vibration thereof, may be minimized compared to that of the piezoelectric energy harvester 100 having a cantilever structure, and an active region of the piezoelectric energy harvester 200 may be maximized. Further, it is possible to make a structure having a higher energy density by arraying a plurality of piezoelectric energy harvesters.

In one embodiment, the natural frequency of the piezoelectric energy harvesters 200, 400 and 500 may be may be tuned according to the weight of the proof masses 210, 410 and 510. The natural frequency of the piezoelectric energy harvester 200, 400 and 500 may be calculated using the following equation.

$${f}_{n} = \frac{{f}_{0}}{\sqrt{α m + 1}} \qquad ( 4 )$$

wherein “fₙ” indicates a natural frequency of the piezoelectric energy harvester having a proof mass, “f₀” indicates a natural frequency of the piezoelectric energy harvester without the proof mass, “m” indicates a weight of the proof mass, “a” indicates a constant associated with a type of the piezoelectric energy harvester. As can be understood from equation (4), the natural frequency of the piezoelectric energy harvester may be tuned by adjusting the weight of the proof masses 210, 410 and 510 in the piezoelectric energy harvesters 200, 400 and 500.

Any reference in this specification to “one embodiment,” “an embodiment,” “example embodiment,” “illustrative embodiment,” etc. means that a particular feature, structure or characteristic described in connection with the embodiment may be included in at least one embodiment of the present invention. The appearances of such phrases in various places in the specification are not necessarily all referring to the same embodiment. Further, when a particular feature, structure or characteristic is described in connection with any embodiment, it is submitted that it is within the purview of one skilled in the art to affect such feature, structure or characteristic in connection with other embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, numerous variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A piezoelectric energy harvester comprising:
an elastic substrate having a spiral spring structure;
a first electrode formed on the elastic substrate;
a piezoelectric film formed on the first electrode; and
a second electrode formed on the piezoelectric film.

2. The piezoelectric energy harvester of claim 1, further comprising:
a proof mass attached to the piezoelectric energy harvester, the proof mass tuning a natural frequency of the piezoelectric energy harvester.

3. The piezoelectric energy harvester of claim 2, wherein the proof mass is attached to an end of the piezoelectric film.

4. The piezoelectric energy harvester of claim 1, wherein the piezoelectric film is polarized in a direction perpendicular to the first and second electrodes.

5. The piezoelectric energy harvester of claim 4, wherein the spiral spring structure is one of a circular or polygonal spiral spring structure.

6. The piezoelectric energy harvester of claim 1, wherein the substrate is formed of a silicon wafer or a silicon nitride deposited silicon wafer.

7. The piezoelectric energy harvester of claim 6, wherein the substrate comprises a film formed of at least one of spring-steel, copper, brass, bronze, glass fiber and fiber reinforced plastic.

8. The piezoelectric energy harvester of claim 1, wherein the piezoelectric film is formed on the elastic substrate by thin film or thick film.

9. The piezoelectric energy harvester of claim 1, wherein the first and second electrode are formed of at least one of silver, platinum, gold, aluminum, nickel, copper-nickel alloy.

10. The piezoelectric energy harvester of claim 1, wherein the piezoelectric energy harvester is fabricated using a microelectromechanical system.
